(19) United States
(12) Patent Application Publication
(10) Pub. No.: US 2015/0284902 A1
(43) Pub. Date: Oct. 8, 2015

(54) POLYURETHANE DISPERSION BASED SYNTHETIC LEATHERS HAVING IMPROVED EMBOSSING CHARACTERISTICS

(71) Applicants: Debkumar BHATTACHARJEE, Blue Bell, PA (US); Weichao GU, Shanghai (CN); Ning KANG, Qingdao, Shandong (CN); Bo LIU, Shanghai (CN); Yunfei YAN, Shanghai (CN); Hongliang ZHANG, Shanghai (CN); Chao Zhang, Shanghai (CN)

(72) Inventors: Debkumar Bhattacharjee, Blue Bell, PA (US); Ning Kang, Qingdao (CN); Hong Liang Zhang, Shanghai (CN); Yunfei Yan, Shanghai (CN); Weichao Gu, Shanghai (CN); Bo Liu, Shanghai (CN); Chao Zhang, Shanghai (CN)

(21) Appl. No.: 14/433,916

(22) PCT Filed: Oct. 16, 2012
(86) PCT No.: PCT/CN2012/083020

§ 371 Date: Apr. 7, 2015

(51) Int. Cl. D06N 3/00; D06N 3/14; C08J 9/00; C08J 9/30; C08J 9/36

(52) U.S. Cl. CPC D06N 3/0047; C08J 9/30; C08J 9/365; C08J 9/0033; C08J 9/0028; D06N 3/0077; D06N 3/14; C08J 2375/08; D06N 2211/28

(57) ABSTRACT

Described herein are methods of preparing PUD based, poromeric, synthetic leathers having improved embossing characteristics, the methods comprising: preparing a polyurethane prepolymer, wherein the prepolymer comprises at least one isocyanate resin, and at least two polyols; preparing a first mixture comprising the polyurethane prepolymer, water, a chain extender, and a first surfactant that comprises at least one surfactant; preparing a second mixture comprising the first mixture, a thickening agent, and a second surfactant the comprises at least one surfactant, frothing the second mixture and thereby forming a frothed second mixture; applying the frothed second mixture to a fabric and thereby forming a coated fabric; optionally adjusting the thickness of the frothed third mixture on the fabric; and drying the coated fabric.

### BACKGROUND OF THE INVENTION

Currently, most polyurethane (PU) synthetic leathers are made using organic solvents, such as dimethylformamide, methylethyl ketone (MEK) and toluene. These solvents vaporize during manufacture and post manufacturing, which leads to potential health issues for the manufacturing staff, the end users of the synthetic leather, and the environment. As a result, the European standard for the solvent PU based synthetic leather was changed to require less than 10 ppm DMF in the leather. Making such leathers is a challenge using organic solvent based methodologies. As a result, the use of solvent free or water borne PU (also known as polyurethane dispersion or PUD) has received attention, as it uses little, if any, organic solvent.

PUD is an aqueous emulsion of PU particles in water having high solid content, small particle size, and prolonged stability (up to six months or longer). When making synthetic leather using PUD, the following general method is used: 1) PUD is frothed 2) the frothed PUD is applied to a fabric, 3) the thickness of the frothed PUD is adjusted using methods known in the art, and 4) the now coated fabric is cured to form a synthetic leather having a poromeric layer. See U.S. Pat. No. 7,306,825 for an example of this methodology. Synthetic leather derived from PUD is similar to that made from PU and an organic solvent. It is breathable, and has good hand-feel. More importantly, the PUD synthetic leather is low in volatile organic compounds. However, while the PUD synthetic leather is acceptable, it does suffer from some disadvantages, such as having poor embossing characteristics. This is unfortunate, because embossable synthetic leathers are very desirable in the fashion industry. As a result of having poor embossing characteristics (among other reasons) the application of PUD synthetic leather has been limited.

It would be advantageous to develop a PUD based synthetic leather that had improved embossing characteristics and reduced cost of preparation.

### SUMMARY OF THE INVENTION

In one aspect, provided herein are methods of preparing PUD based, poromeric, synthetic leathers having improved embossing characteristics, the methods comprising:
preparing a polyurethane prepolymer by reacting a mixture comprising, at least one isocyanate resin, and at least two polyols;
mixing said polyurethane prepolymer, with water, at least one surfactant and other optional additives to form a first mixture;
adding at least one chain extender to the first mixture to form a polyurethane/urea dispersion (PUD);
preparing a second mixture comprising the PUD, at least one thickening agent, and at least one surfactant;
frothing the second mixture and thereby forming a frothed second mixture; applying the frothed second mixture to a fabric and thereby forming a coated fabric;
optionally adjusting the thickness of the frothed third mixture on the fabric; and drying the coated fabric.

In another aspect, provided herein are methods of preparing PUD based, poromeric, synthetic leathers having improved embossing characteristics, the methods comprising:
preparing a polyurethane prepolymer by reacting a mixture comprising, at least one isocyanate resin, and at least two polyols;
mixing said polyurethane prepolymer, with water, at least one surfactant and other optional additives to form a first mixture;
adding at least one chain extender to the first mixture to form a polyurethane/urea dispersion (PUD) having urea to urethane ratio of 0.9 to 0.06;
preparing a second mixture comprising the PUD, at least one thickening agent, and at least one surfactant;
frothing the second mixture and thereby forming a frothed second mixture;
applying the frothed second mixture to a fabric and thereby forming a coated fabric;
optionally adjusting the thickness of the frothed third mixture on the fabric; and
drying the coated fabric.

PUD based, poromeric, synthetic leathers having improved embossing characteristics made according to the aforementioned methods are also disclosed herein.

The PUD based synthetic leathers disclosed herein are externally stabilized, i.e., they require the presence of at least one surfactant in the PUD containing mixture. Likewise, the methods disclosed herein utilize externally stabilized PUDS.

The PUD based synthetic leathers disclosed herein may be used to make synthetic leather for any leather or synthetic leather applications. Particular examples include footwear, handbags, belts, purses, garments, furniture upholstery, automotive upholstery, and gloves.

### BRIEF DESCRIPTION OF THE FIGURES

FIG. 1 is a picture of the surface pattern of the control sample (based on Syntegra 3000 PUD), post-embossment.

FIG. 2 is a picture of the surface pattern of sample 1, post-embossment.

FIG. 3 is a picture of the surface pattern of sample 2, post-embossment.

FIG. 4 is a picture of the surface pattern of sample 3, post-embossment.

### DETAILED DESCRIPTION

The methods and leathers disclosed herein utilize at least one isocyanate resin when preparing the polyurethane prepolymer. Each isocyanate resin is independently aliphatic, cycloaliphatic, aromatic or hetero aromatic; provided that each isocyanate resin comprises at least two isocyanate groups (i.e., it is a polyisocyanate). Representative examples of suitable diisocyanates include 4,4′-diisocyanatodiphenylmethane, 2,4′-diisocyanatodiphenylmethane, isophorone diisocyanate, p-phenylene diisocyanate, 2,6 toluene diisocyanate, polyphenyl polymethylene polyisocyanate, 1,3-bis(isocyanatomethyl)cyclohexane, 1,4-diisocyanatocyclohexane, hexamethylene diisocyanate, 1,5-naphthalene diisocyanate, 3,3′-dimethyl-4,4′-biphenyl diisocyanate, 4,4′-diisocyanatodicyclohexylmethane, 2,4′-diisocyanatodicyclohexylmethane, and 2,4-toluene diisocyanate, or combinations thereof. More preferred diisocyanates are 4,4′-diisocyanatodicyclohexylmethane, 4,4′-diisocyanatodiphenylmethane, 2,4′-diisocyanatodicyclohexylmethane, and 2,4′-diisocyanatodiphenylmethane. In one preferred embodiment, the isocyanate resin is a methylenediphenyl diisocyanate. Still more preferred are 4,4′-diisocyanatodiphenylmethane (also known as 4,4′-MDI) and 2,4′-diisocyanatodiphenylmethane (also known as 2,4′-MDI). Most preferred is 4,4′-MDI. The polyisocyanates may be purified or part of a mixture of polyisocyanates. Examples of commercially available isocyanates include ISONATE 125M and ISONATE 50 OP, both of which are sold by the Dow Chemical Company, and SUPRASEC 1814, which is sold by Huntsman.

The methods and leathers disclosed herein utilize at least two polyols, wherein the polyols are polyether polyols, polyester polyols, aromatic polyols, or combinations thereof. Polyols include one or more other polyether or polyesters polyols of the kind typically employed in processes to make polyurethanes. Other compounds having at least two isocyanate reactive hydrogen atoms may also be present, for example polythioether polyols, polyester amides and polyacetals containing hydroxyl groups, aliphatic polycarbonates containing hydroxyl groups, amine terminated polyoxyalkylene polyethers, and preferably, polyester polyols, polyoxyalkylene polyether polyols, and graft dispersion polyols. Mixtures of two or more of the aforesaid materials may also be employed. In one preferred embodiment, the mixture of at least two polyols comprises at least one polyether polyol, and at least one polyester polyol.

The term “polyester polyol” as used herein includes any minor amounts of unreacted polyol remaining after the preparation of the polyester polyol and/or unesterified polyol (for example, glycol) added after the preparation of the polyester polyol. Suitable polyester polyols can be produced, for example, from aliphatic organic dicarboxylic acids with 2 to 12 carbons, preferably aliphatic dicarboxylic acids with 4 to 6 carbons, and multivalent alcohols, preferably diols, with 2 to 12 carbons. Examples of aliphatic dicarboxylic acids include succinic acid, glutaric acid, adipic acid, suberic acid, azelaic acid, sebacic acid, decanedicarboxylic acid, maleic acid, fumaric acid, phthalic acid, isophthalic acid, and terephthalic acid. The corresponding dicarboxylic acid derivatives may also be used such as dicarboxylic acid mono-or di-esters of alcohols with 1 to 4 carbons, or dicarboxylic acid anhydrides. Examples of divalent and multivalent alcohols, especially diols, include ethanediol, diethylene glycol, glycerine and trimethylolpropanes or mixtures of at least two of these diols. Polyester polyols derived from vegetable oils (natural oil polyols or NOPs) may also be used.

Useful aromatic polyols include aromatic polyether polyol or an aromatic polyester polyol or combinations of the two. Particularly desirably aromatic polyester polyol is an aromatic dicarboxylic acid with 8 to 24 carbons. While the aromatic polyester polyols can be prepared from substantially pure aromatic dicarboxylic acids, more complex ingredients are advantageously used, such as the side stream, waste or scrap residues from the manufacture of phthalic acid, terephthalic acid, dimethyl terephthalate, and polyethylene terephthalate. Other residues are dimethyl terephthalate (DMT) process residues, which are waste or scrap residues from the manufacture of DMT. The present applicants have observed that for certain applications it is particularly advantageous for reasons of foam performance and processing to have present in the polyol composition both the “Novolac” polyol and an additional aromatic polyol which can be an aromatic polyether or aromatic polyester polyol. Polyether polyols are compounds that have an ether backbone and further comprise at least two OH groups. Polyether polyols are commonly made by reacting monomeric compounds (either alone or in combination), such as glycerine (a triol), pentaerythritol (a tetraol), ethylene glycol (a diol), diethylene glycol (a diol of the formula: HOCH₂CH₂OCH₂CH₂OH), and/or sucrose with ethylene oxide, propylene oxide and/or butylene oxide in the presence of an initiator and/or a catalyst. Suitable initiators include aliphatic and aromatic amines, such as monoethanolamine, vicinal toluenediamines, ethylenediamines, and propylenediamine. Useful catalysts include strong bases, such as NaOH, or KOH, and double metal cyanide catalysts, such as zinc hexacyanocobalt-t-butanol complex. Common polyether polyols include polyethylene glycol (PEG), polypropylene glycol, and poly(tetramethylene ether)glycol. Preferred polyether polyols are comprised of monohydroxyl polyethylene oxide units. In a preferred embodiment, at least one of the polyols used herein is a polyether polyol having an average molecular weight of 400 to 1500 g/mol.

Some preferred polyols include VORANOL 9287A (a 2000 molecular weight, 12 percent ethylene oxide capped diol stabilized with alkyldiphenylamine, a product of The

Dow Chemical Company); CARBOWAX Polyethylene Glycol (PEG) 1000 (CAS # 25322-68-3, a 1000 molecular weight, polyethylene glycol monomethyl ether, >=99.0%, a product of The Dow Chemical Company); Bester 48 (a polyester polyol having a molecular weight of approximately 1,000, it is an ethylene glycol/butane diol/adipic acid (EG/BD/AA) type polyol that is a product of The Dow Chemical Company); Bester 104 (a DEG/IPA/AA based polyester polyol, i.e., a diethylene glycol/isopropyl alcohol/adipic acid based polyester polyol); PEG 400 (a 400 molecular weight, polyether polyol based on ethylene oxide that is a product of the Sinopharm Chemical Reagent Corporation, Shanghai, China); PPG 425 (a propylene oxide based polyether polyol have a molecular weight of 425 that is a product of The Dow Chemical Company); and DEG (diethylene glycol, which is sold by Sigma).

The polyols used in the methods and leathers described herein typically weigh less than 5,000 g/mol. More preferably, the polyols weigh less than 4,000 g/mol, with polyols having a molecular weight of less than 3,000 g/mol being even more preferred. Still more preferably, each polyol has an average molecular weight of less than 2000 g/mol.

The use of a strong base catalyst to make a polyether polyol often causes the polyether polyol to be too basic, which has a detrimental effect on the aforementioned prepolymer. Consequently, it is often necessary to treat the polyether polyol with a scavenger compound, which reacts with the residual base and makes the prepolymer more acidic. Suitable scavenger compounds include benzoyl chloride, and 85% phosphoric acid, with benzoyl chloride being preferred. Typically, adding aqueous acids introduces excess water into the prepolymer, which will react with the isocyanate and adversely impact the resulting leather. The inventors typically use a scavenger compound to adjust the net controlled polymerization rate of the mixture to be lower than −10. ASTM D 6437-05 corresponds to the CPR procedure.

In one embodiment, the methods and leathers utilize two polyols, wherein one polyol is a polyester polyol and the other is a polyether polyol. Alternatively, the two polyols are both polyether polyols.

In another embodiment, the methods and leathers utilize three polyols, wherein one polyol is a polyester polyol and the other two are polyether polyols. Alternatively, 1) two polyols are polyester polyols, while one polyol is a polyether polyol; 2) all three polyols are polyether polyols; or 3) all three polyols are polyester polyols.

In still another embodiment, the methods and leathers utilize four or more polyols. In such cases any combination of polyols may be used. Preferably, the polyurethane prepolymer contains less than five polyols.

In the methods and leathers disclosed herein, the weight ratio of the polyols to the isocyanate resin in the prepolymer is typically 1:1 to 4:1. Preferably, the weight ratio is 1:1 to 3:1. More preferably, the weight ratio is 2:1 to 3:1.

The weight ratio of the surfactant to the combined weight of the polyols and the isocyanate(s) is 1:5 to 0.01:5. More preferably this ratio is 0.3:5 to 0.1:5.

The weight ratio of water to the combined weights of the polyols, the isocyanate(s), surfactants and chain extender(s) is 25:75 to 99:1. More preferably, the ratio is 40:60 to 60:40.

In one embodiment, the polyurethane prepolymer is made by combining a liquid isocyanate resin and at least two liquid polyols. If necessary, solid isocyanate may be melted to form the liquid isocyanate resin.

In another embodiment, the polyurethane prepolymer is made by melting the isocyanate resin, heating the at least one polyol and then combining the melted isocyanate resin and the heated at least one polyol. Preferably, the melted isocyanate is combined with a mixture comprising at least two polyols, wherein the polyol mixture is heated to 50-90° C. before it is combined with the melted isocyanate. More preferably, the polyol mixture is heated to a temperature that is at least 60° C.; still more preferably, it is heated to at least 70° C., with 80° C. being particularly preferred. If all reagents are liquids or if a solid reagent is soluble in the other liquid reagents, then the preheating of the polyol mixture is optional.

Chain extenders are bifunctional or polyfunctional, low molecular weight (typically weighing from 18 up to 500 g/mol) compounds that contain at least two active hydrogen containing groups. Any chain extender known to be useful to those of ordinary skill in the art of preparing polyurethanes can be used in the leathers and methods disclosed herein. Examples of chain extenders include diols, polyols, diamines, polyamines, hydrazides, acid hydrazides, and water. Of these, amine containing chain extenders and water are preferred. Furthermore, one or a combination of chain extenders may be used. For example, the chain extender may be mixed with or otherwise contain water.

Examples of chain extenders include water, piperazine, 2-methylpiperazine; 2,5-dimethylpiperazine; 1 ,2-diaminopropane; 1 , 3-diaminopropane; 1 ,4-diaminobutane; 1,6-diaminohexane, isophorone diamine, mixtures of isomers of 2,2,4- and 2,4,4-trimethyl hexamethylene diamine, 2-methyl pentamethylene diamine, diethylene triamine, dipropylenetriamine, triethylenetetramine, 1,3- and 1,4-xylylene diamine, a,a,a′,a′-tetramethyl-1,3- and -1,4-xylylene diamine and 4,4′-dicyclohexylmethanediamine, 3,3′-dimethyl-4,4′-dicyclohexylmethanediamine, 1 ,2-cyclohexanediamine;1 ,4-cyclohexanediamine, dimethylethylene diamine, hydrazine or adipic acid dihydrazide ethylene glycol; ethylene oxide; propylene oxide; aminoethylethanolamine (AEEA); aminopropylethanolamine, aminohexylethanolamine; aminoethylpropanolamine, aminopropylpropanolamine, aminohexylpropanolamine; cyclohexane dimethanol; hydroquinone bis(2-hydroxyethyl)ether (also known as HQEE); ethanolamine; diethanolamine; piperazine, JEFFAMINE D-230 (a polyether with two amino terminating groups, having a molecular weight of approximately 230 that is sold by the Huntsman Co.), methyldiethanolamine; phenyldiethanolamine; diethyltoluenediamine, dimethylthiotoluenediamine and trimethylolpropane. Particularly preferred chain extenders include water, AEEA, piperazine and 1,4-diaminobutane. The typical ratio of the NCO in the prepolymer to the diamine chain extender is 8:1

In one embodiment, two chain extenders are used. In such a situation, the first chain extender is water, and the second chain extender may be a diamine or polyamine based compound, Preferred diamines for use in this embodiment include piperazine and 1,4-diaminobutane, with 1,4-diaminobutane being the most preferred. When two chain extenders are used, they may be added simultaneously to the mixture, or sequentially.

After the polyol mixture is combined with the isocyanate resin, the NCO percent is periodically determined and the reaction is complete when the desired NCO content is obtained. Preferably, the NCO:OH ratio in the polyurethane prepolymer is 2.5:1 to 1.1:1, More preferably, it is 2,1:1 to 1.4:1. Still more preferably, the ratio is 1.8:1 to 1.5:1. The NCO content may be determined using methods known in the art, such as ASTM # 2572-87.

Typically the reaction between the isocyanates and the polyols takes less than 24 hours to complete. More typically, it takes less than 12 hours. More typically, the reaction time is less than 6 hours and more than 30 minutes.

The NCO ratio in the prepolymer is important because it ultimately impacts the embossability of the resulting synthetic leather. When the prepolymer is added to the water, the residual NCO groups will react with the water to form carbamic acids, which spontaneously release CO₂ and result in the formation of a primary amine. This primary amine can then react with the remaining NCO groups to form a urea linkage (and if present, any amine based chain extenders will also react with the remaining NCO groups to form urea linkages.) These urea based compounds have higher viscous flow temperatures (T_{f}) and higher crystallinity, when compared to a comparable urethane linkage. If the NCO ratio in the prepolymer is too high, then large amounts of urea linkages are formed. And if too many urea linkages are formed, then the resulting synthetic leather is difficult to emboss. But by controlling the NCO ratio, it is possible to make a synthetic leather that has desirable embossing characteristics. For an example, see Scheme 1 (below), where MDI is the isocyanate and R is part of the chain extender.

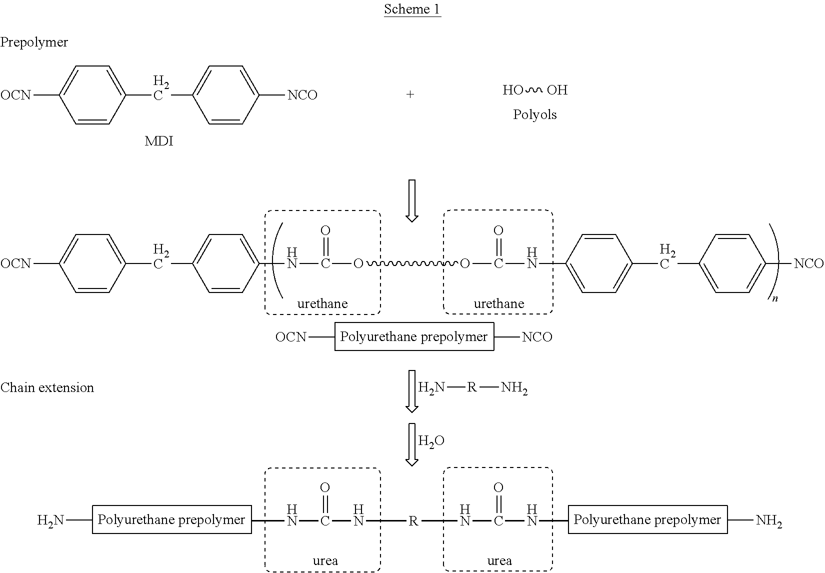

In the “Prepolymer” section of Scheme 1, the urethane groups are formed when the isocyanate (which in the scheme is derived from MDT) reacts with the polyol. Essentially all urethane linkages are formed during the prepolymer step, and essentially all polyols are consumed during this step. The urethane mole number is equal to OH mole number. The resulting urethane contains terminal isocyanate groups, which may react with any amine or water molecules that may be present, and thus result in either urea linkages, which continues the growth of the polymer chain.

The NCO groups will form either urethane or urea groups. The urea mole number is related to the residual amount of NCO present, after the NCO groups react with the polyols. If an NCO group reacts with an amine group, one NCO will be converted to one urea. But if one NCO reacts with water, as shown in FIG. 2, the first NCO group is converted into an amine, which then reacts with the second NCO group to form a urea linkage.

So, the Urea/Urethane ratio is determined by 2 factors: the first being the NCO/OH ratio in the prepolymer synthesis step, and the second being the diamine chain extension ratio in the chain extension step, which is based on the amount of NCO that reacts with the diamine chain extender.

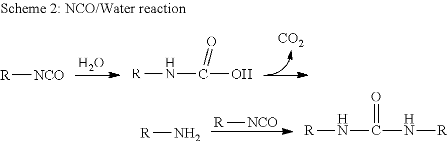

Scheme 2 illustrates the reaction of an isocyanate with a molecule of water to form a carbamic acid, which spontaneously decomposes by losing a molecule of CO₂, to form a primary amine. The primary amine then reacts with a residual isocyanate group and forms a urea. It should be understood that while Scheme 2 shows the amine being generated from a decomposed isocyanate, the amine may come from the chain extender.

In one embodiment of the methods disclosed herein, the solid content of the first mixture is 40-70% or 45-65% by weight. More preferably, it is 50-55% by weight. The solid content may be determined by taking a sample of the first mixture, weighing it, removing the solvent and then reweighing the sample.

In one preferred embodiment, the methods of preparing poromeric, synthetic leather having improved embossing characteristics comprise:
melting 4,4′-methylenediphenyl diisocyanate;
preparing a polyol mixture comprising at least two polyols, wherein at least one polyol is a polyether polyol;
heating the mixture of at least two polyols to a temperature of at least 30° C. (preferably, 30-60° C.);
optionally adding a base scavenger to said polyol mixture;
preparing a polyurethane prepolymer by reacting a mixture comprising the melted diisocyanate, the heated polyol mixture and the optional base scavenger;
mixing said polyurethane prepolymer with water, at least one surfactant, and water, to form a first mixture;
adding at least one chain extender to the first mixture to form a polyurethane dispersion (PUD) having urea to urethane ratio of 0.9 to 0.06;
mixing the PUD;
preparing a second mixture comprising the PUD, at least two surfactants, and a thickener;
frothing the second mixture and thereby forming a frothed second mixture;
applying the frothed second mixture to a fabric and thereby forming a coated fabric;
optionally adjusting the thickness of the frothed second mixture on the fabric; and drying the coated fabric.

As used herein, a polyurethane dispersed in water is referred to as a PUD. When a polyurethane is dispersed in water, it is understood that the water optionally further comprises other, additional solvents, such as C₁-C₆ alcohols, ethers, polyethers, DMF, and NMP. The water may contain one or more than one additional solvent. Preferably, these additional solvents comprise less 10% by weight, based on the weight of the water and the additional solvent or solvents. More preferably they comprise less than 5% by weight. Still more preferably, it is less than 1% by weight. Most preferably, non-water solvents are not present in PUD. And while deionized and/or distilled water may be used, it is not required.

The leathers and methods of making the leathers disclosed herein, optionally further comprise an additive that is a; fillers (such as wood fibers, CaCO₃, SiO₂, and TiO₂), a flame retardant, a pigment, a flowing additive, handfeel additive, antioxidant, anti-UV additive, antistatic agent, antimicrobial agent, or combinations thereof. Wood fibers also include wood floor. In one embodiment, the leathers and methods require the presence of at least one of the aforementioned additives.

The aforementioned fillers, when present, account for 0.1-50% by weight of the composition (excluding the fabric). More preferably, when present, the fillings account for 0.1-40% by weight of the composition. Still more preferably, the fillers account for 0.1-30% by weight of the composition.

The non-filler additives, i.e., the aforementioned additives, not including the fillers, typically account for 0.01-20% by weight of the composition. More preferably, the non-filler additives account for 0.1-10% by weight of the composition. Still more preferably, the non-filler additives account for 1-5% by weight of the composition. Flowing additives, handfeel additives, antioxidants, anti-UV additives, antistatic agents, and antimicrobial agents are typically comprise less than 5% by weight of the composition. The additives may be added to the polyester polyol modified PUD, to the mixture comprising the polyester polyol modified PUD or combinations thereof. Examples of suitable surfactants used in the leathers and methods disclosed herein include, cationic, anionic, or nonionic surfactants. Suitable classes of surfactants include, but are not restricted to, sulfates of ethoxylated phenols such as poly(oxy-1,2-ethanediyl)-α-sulfo-ω-(nonylphenoxy) ammonium salt; alkali metal fatty acid salts such as alkali metal oleates and stearates; polyoxyalkylene nonionics such as polyethylene oxide, polypropylene oxide, polybutylene oxide, and copolymers thereof; alcohol alkoxylates; ethoxylated fatty acid esters and alkylphenol ethoxylates; alkali metal lauryl sulfates; amine lauryl sulfates such as triethanolamine lauryl sulfate; quaternary ammonium surfactants; alkali metal alkylbenzene sulfonates such as branched and linear sodium dodecylbenzene sulfonates; amine alkyl benzene sulfonates such as triethanolamine dodecylbenzene sulfonate; anionic and nonionic fluorocarbon surfactants such as fluorinated alkyl esters and alkali metal perfluoroalkyl sulfonates; organosilicon surfactants such as modified polydimethylsiloxanes; and alkali metal soaps of modified resins. Exemplary surfactants include disodium octadecyl sulfosuccinimate, sodium dodecylbenzene sulfonate, sodium alpha olefin sulfonate, sodium stearate and ammonium stearate. Typically the total amount of surfactant used is less than 10%, based on the total weight of the dried synthetic leather, When the surfactant is mixed with the PUD, it is used to stabilize the air bubbles in the frothed PUD. The surfactant or surfactants are sometimes used as a concentrate in water. When two or more surfactants are being used, they may be added to the mixture simultaneously or one after the other.

The surfactants in the first and second mixtures may be the same or different. Preferably, the surfactant in the first mixture is an external surfactant and comprises a sulfonate salt, with sodium dodecylbenzene sulfonate and sodium alpha olefin sulfonate being preferred. Sodium dodecylbenzene sulfonate is the most preferred sulfonate salt in the first mixture.

In one embodiment, the second surfactant comprises at least one of ammonium stearate, disodium octadecyl sulfosuccinimate or cocamidopropyl betaine. Preferably, the second surfactant comprises at least two of the aforementioned surfactants. Still more preferably, the second surfactant comprises all three of the aforementioned surfactants.

The surfactant or surfactants are sometimes used as a concentrate in water. Further, the surfactant(s) may be added to the first mixture or the second mixture or said mixtures may be added to the surfactant(s). When two or more surfactants are being used, they may be added to the mixture simultaneously or one after the other.

Embossing is well known in the art as a method of producing raised and/or sunken patterns or designs in a material, such as a metal, leather or a synthetic material. Embossing is typically performed by heating a material (although, not always), contacting the material with at least one die, and then applying pressure so that the die presses into the material, for enough time to cause the pattern from the die to be transferred to the material. Pressure may be applied using a hand press, a pneumatic press, or any other method known in the art. If desired, two matching dies may be used, i.e., a male and a female die may be used.

In an embodiment of the aforementioned methods, the resulting poromeric, synthetic leather is embossed using methods well known in the art. The embossing pattern may be that of natural leather or any other desired pattern.

Thickeners are well known in the art and any thickener may be used in the leathers and methods disclosed herein. The thickener may be non-associative or associative. It may be a cellulose ether derivative, natural gum alkali swellable emulsion, a clay, an acid derivative, an acid copolymer, a urethane associate thickener (UAT), a polyether urea polyurethane (PEUPU), a polyether polyurethane (PEPU) or a hydrophobically modified ethoxylated urethane (HEUR). One preferred thickener is based on an acrylic acid copolymer, with ethylene acrylic acid copolymer (which is sold by Dow Chemicals as ACUSOL 810A) being particularly preferred. Preferably, the thickener does not cause the PUD containing mixture to become unstable.

In the above methods, unless specifically identified, the order of combining the components of the prepolymer, the first mixture, and the second mixture does not matter.

Frothing may be accomplished by any method known in the art. Examples include mechanical mixing, bubbling a gas into the mixture or a combination thereof.

Likewise, applying the frothed mixture to the fabric may also be accomplished by any method known in the art.

The synthetic leathers and methods described herein utilize a fabric that is coated with the frothed mixture. Many different fabrics that are known in the art may be used. The fabric may be woven or nonwoven. In one embodiment, the fabric is a non-woven fabric. The fabric may be made by any suitable method such as those known in the art. The fabric may be prepared from any suitable fibrous material, such as, but not limited to, synthetic fibrous materials and natural or semi synthetic fibrous materials and mixtures or blends thereof Examples of synthetic fibrous materials include polyesters, polyamides, acrylics, polyolefins, polyvinyl chlorides, polyvinylidene chlorides, polyvinyl alcohols and blends or mixtures thereof. Examples of natural semi-synthetic fibrous materials include cotton, wool and hemp.

In the leathers and methods disclosed herein, the fabric is optionally impregnated with a polymer resin. Acceptable resins include isocyanate containing resins, such as polyisocyanates (which contain at least two isocyanate groups) were discussed above.

The impregnation of the fabric may be conducted by any suitable method known in the art. Examples include dipping, spraying or doctor blading. After impregnating, the impregnated textile may have excess resin removed to leave the desired amount of dispersion within the textile. Typically, this may be accomplished by passing the impregnated textile through rubber rollers.

Generally, the impregnated fabric is impregnated with a resin in an organic solvent (which makes a solution) or water (which makes a dispersion). Typical solvents include dimethylformamide (DMF), methylethyl ketone (MEK) and toluene, although other solvents will afford acceptable results. Generally, the organic solvent used to impregnate the fabric will contain 0.5-50% by weight of resin. More preferably, the organic solvent will contain 5-30% by weight of resin. Still more preferably, 15-25% by weight of resin.

Example of suitable resins include isocyanate containing resins. The ability to prepare an impregnated fabric, using either a solution or a dispersion is well known in the art.

The frothed mixture may be applied to the fabric using any suitable method known in the art. Examples include using a Labcoater type LTE-S (Werner Mathic AG).

Likewise, the thickness of the froth on the fabric can be adjusted using methods known in the art. Examples include using a doctor blade assembly.

The methods require drying or otherwise treating/curing the coated fabric (i.e., the optionally impregnated fabric that is coated with the frothed mixture) so that the synthetic leather forms. Suitable drying conditions include subjecting the froth coated fabric to 1) a constant temperature until dry, 2) a temperature gradient wherein the temperature changes over time, or 3) a multistep drying regime where the temperature is held for a set amount of time and then changed to a different temperature, which is then held for a set amount of time (3, 4, 5, or more drying steps may also be used). The drying times for each step may be the same or different. Typical drying times are from a few seconds up to one hour. One example of a suitable drying protocol is to subject the froth covered, optionally impregnated fabric to a temperature that is at least 80° C. and no more than 250° C. More preferably, the optionally impregnated fabric is heated to a temperature of 95-105° C. for 4-10 minutes and then to a temperature of 165-175° C. for 3-10 minutes. During the drying process, the water evaporates and the polyolefin sets (which may include melting of at least some of the material coated onto the fabric) and thereby forms the final coating. The drying process should not cause decomposition of any of the synthetic leather components.

Typically, the drying is performed in an oven at atmospheric pressure, but it can be performed at pressures above or below atmospheric pressure.

### Experimental Procedures

TABLE 1
Description of the Raw materials

| Component | Grade name | Characteristic | Supplier |
|---|---|---|---|
| Polyol | VORANOL | 2000 MW, 12% EO | Dow |
| | 9287A | Capped, PO diol. | |
| Polyol | CARBOWAX ™ | MW = 1000, Poly- | Dow |
| | Methoxy | ethylene glycol mono- | |
| | polyethylene | methyl ether >= | |
| | Glycol 1000 | 99.0% | |
| Polyol | Bester 48 | Polyester polyol, | Dow |
| | | MW = 1000, | |
| | | EG/BD/AA type | |
| polyol | PEG 400 | Polyether polyol, | Sino |
| | | MW = 400, EO | Pharm |
| | | | Chemical |
| Polyol | PPG 425 | Polyether polyol, | Dow |
| | | MW = 425, PO | |
| Polyol | DEG | Diethylene glycol | Sigma |
| Isocyanate | Isonate | 4,4′-Methylene- | Dow |
| | 125 M | diphenyl diisocyanate = | |
| | | 98% | |
| surfactant | Rhodacal | Sodium dodecylbenzene | Rhodacal |
| | DS-4 | sulfonate(23% solid) | |
| Chain | Amino Ethyl | Amino Ethyl Ethanol | TCI |
| Extender | Ethanol Amine | Amine | |
| Thicker | ACUSOL 810A | acrylic acid copolymer | Dow |
| Surfactant | STANFAX | ammonium stearate | Para-chem |
| | 320 | | |
| Surfactant | STANFAX | disodium octadecyl | Para-chem |
| | 318 | sulfosuccinimate | |
| Surfactant | STANFAX | cocamidopropyl betaine | Para-chem |
| | 590 | | |

In the above table, EO means ethylene oxide, while PO means propylene oxide.
General Procedure for the Preparation of PUD based, Poromeric Synthetic Leather

### Preparation of the Prepolymer

Put at least one isocyanate resin into the reactor. If a resin is a solid, heat it until it is melted.

Combine the polyols in a separate reaction vessel. If the isocyanate is a solid at ambient temperature, heat the polyol mixture to a temperature higher than the isocyanate's melting point. Adjust the net-controlled polymerization rate (CPR) to be lower than −10 using a scavenger compound, such as benzoyl chloride. Combine the polyol mixture and the isocyanate. Stir and heat the combined mixture. Test the NCO % periodically using ASTM method ASTM D 2572-87. When the desired NCO content is reached, reduce the temperature of the reaction mixture.

### Preparation of the Polyurethane Dispersion (PUD)

The prepolymer (from above) was placed in a plastic jar. The jar was secured and a Cowles blade was inserted into the prepolymer such that the blade is just covered. At least one surfactant is added to the prepolymer, with mixing at 3000 rpm. Cold (˜5° C.) deionized water (DI water) is slowly added to the mixture. Gradually, the water-in-oil emulsion is converted into an oil-in-water dispersion. A solution of chain extender in DI water is slowly fed into the dispersion, the final dispersion is allowed to degas under ambient condition with random stirring.

### Preparation of the Poromeric Synthetic Leather

The PUD (from above) is combined with three surfactants, such as ammonium stearate (STANFAX 320, Para-chem), disodium octadecyl sulfosuccinimate (STANFAX 318, Para-chem), cocamidopropyl betaine (STANFAX 590, Para-chem) and a thickener, such as acrylic acid copolymer (ACUSOL 810A, Dow). The pre-frothed PUD has a solids content of 40-60 percent by weight and the viscosity of the thickened PUD is adjusted to be 15000 cp to 28000 cp.

The thickened PUD is frothed using, for example, a Model 2MT1A foam machine (E.T. OAKES Corp.) run at 1000 rpm. The density of the froth is typically about 0.50-0.85 g/cm³. The froth is applied to a fabric that was previously attached to a pin frame, using (for example) a Labcoater type LTE-S (Werner Mathic AG). The doctor knife is positioned at 1.8-2.5mm between the roller and knife (including resin and fabric) and the thickness of the frothed PUD on the fabric is adjusted. The coated fabric is then dried by placing it in an oven until dry. Typical drying temperatures and times are 80-110° C. for 2-10 min, and then increasing the oven temperature to 150-180° C. for 1-10 min to form the synthetic leather having a poromeric layer.

### Embossing Process

The resulting poromeric synthetic leather (from above) is placed in a 160° C.-190° C. oven for 10min, and then was be pressed 1-10 MPa for 3s by a cool press machine.

### Control and Experimental Synthetic Leathers

### Preparation of the Control Sample: Syntegra 3000 PUD Synthetic Leather

### Preparation of the Prepolymer

180 g of Isonate 125 M was charged into a three-neck flask and then heated to 45° C. in order to melt it. Then 408 g Voranal 9287A, 12 g MPEG 1000 were premixed and warmed to 55° C. for 1 h before being added to the melted Isonate 125 M. The temperature was increased to 80° C., then maintained for 4-5 h. The reaction was complete once the target NCO % of 7.1% (NCO:OH=3.43) was reached.

### Preparation of the Polyurethane Dispersion (PUD)

524.2 g prepolymer (from above) was placed in a plastic jar. The jar was clamped and a Cowles blade was inserted into it such that the blade was just covered by the prepolymer. 71.74 g of DS-4 mixture was then added to prepolymer and stirred at 3000 rpm. Then cold DI water (5° C.) was slowly added to the stirring the mixture. Over time, the water-in-oil mixture was converted into an oil-in-water dispersion. A solution of 92.29 g chain extender (10% by weight of amino ethyl ethanol amine in water) was then slowly fed into the dispersion with random stirring. The solid content of PUD was 55%.

### Preparation of the Poromeric Synthetic Leather and the Embossing Process

The poromeric synthetic leather was made essentially according to the method described above in the “General Procedure for the Preparation of PUD based, Poromeric Synthetic Leather.” The exact ratios of the reagents may be found in Table 3, below. The embossing process was also conducted essentially as described above.

The Control and experimental examples were made according to the general method (above) and the specific synthetic protocol (below).

Table 2 summarizes the formulation of prepolymer for PUDs and provides data thereon

| | Materials | | | | | | | | |
|---|---|---|---|---|---|---|---|---|---|
| | Voranol | Bester | MPEG | | PPG | Isonate | | | Urea/Urethane |
| Samples | 9287 A | 48 | 1000 | DEG ⁽¹⁾ | 425 ⁽¹⁾ | 125 M | NCO/OH | NCO % | ratio in PUDs* |
| Control | 408 g | 0 g | 12 g | 0 g | 0 g | 180 | 3.43 | 7.1% | 1.458 |
| (Syntegra 3000) | | | | | | | | | |
| PUD 1 | 336 g | 0 g | 12 g | 0 g | 72 g | 180 | 2.1 | 5.3% | 0.66 |
| PUD 2 | 324 g | 0 g | 12 g | 12 g | 72 g | 180 | 1.6 | 3.8% | 0.36 |
| PUD 3 | 150 g | 246 g | 12 g | 12 g | 0 g | 180 | 1.63 | 3.9% | 0.378 |

*In all of the above formulations, the chain extension ratio of diamine is fixed to 20%. (20% of the NCO groups (based on the number of moles) react with the diamine chain extender, AEEA, while the other 80% react with water).
⁽¹⁾ Replacing Voranol 9287 A with DEG and PPG 425 reduces the NCO % of the prepolymer, as the molecular weight of DEG and PPG 425 is lower than that of Voranol 9287A.

Calculation of the Urea/Urethane Ratio from the NCO/OH ratio when the chain extension ratio of diamine is fixed to 20%.

Syntegra 3000 has a theoretical NCO/OH ratio of 3.43:1.

The number of urethane linkages corresponds to the moles of OH present, which is set to one. Urea/urethane ratio=(total moles of NCO−total moles of OH)*20%+(total moles of NCO−total moles of OH)*80%/2=(3.43−1)*20%+(3.43−1)*80%/2=1.458

The 20% corresponds to the number of moles of NCO that react with the diamine, while the 80% corresponds to the number of moles of NCO that react with water.

Thus, the Urea/Urethane ratio is 1.458:1.

TABLE 3
Composition of the Poromeric Synthetic leather

| | Control | | | |
|---|---|---|---|---|
| Materials | Weight/g | Ex. 1 | Ex. 2 | Ex. 3 |
| PUD (Syntegra 3000) | 1000 | 850 | 1000 | 750 |
| Stanfax 320 | 40 | 33 | 40 | 30.2 |
| Stanfax 590 | 11.3 | 10 | 22.4 | 10 |
| Stanfax 318 | 13.1 | 12 | 13.1 | 9.5 |
| Acusol 810A | 60 | 65.1 | 83.2 | 72.3 |
| Viscosity/cp | 17900 | 17800 | 17500 | 15000 |
| Foam density (g/cm³) | 0.748 | 0.689 | 0.702 | 0.690 |

Table 3 summarized the compositions of the control and experimental poromeric synthetic leathers.

The frothed PUDs having lower viscosities (See Table 3), such as Example 3, may be able to penetrate into the fabric better than the PUDs having higher viscosities. The higher viscosity PUDs may also encounter difficulties when using a coating blade to make a film.

It is also possible to control the density of the foam, using methods known in the art.

### EXAMPLES

### Inventive Example 1: Synthetic Leather Example 1

The prepolymer was made using the formulations depicted in Table 2 and essentially according to the method described above. Prepolymer: PU prepolymer is prepared by charging 180 g Isonate 125 M into a three-neck flask, which was heated at 45° C. for melt solid MDI to liquid. 336 g Voranal 9287A , 72 g PPG 425, 12 g MPEG 1000 is premixed and warmed at 55° C. for 1 h before added to flask. Increase the temperature to 80° C., keep 80° C. for 4-5 h to reach the target NCO % of 5.3% (NCO:OH=2.10).

PU dispersion: 524.2 g prepolymer was placed in a plastic jar. The jar was clamped and a Cowles blade was inserted into prepolymer such that the blade is just covered by prepolymer. 71.74 g DS-4 mixture was charged into prepolymer, following this procedure, the mixture was stirred with Cowles blade at 3000 rpm, and cold DI water (5° C.) is added into the mixture slowly as the water-in-oil was converted into an oil-in-water dispersion. A solution of 68.89 g chain extender (10% AEEA in water) is slowly fed into the dispersion with random stirring. The solid content of final dispersion PUD 1 is 55%.

Synthetic Leather

A poromeric layer of the synthetic leather was made using frothing PUD. The frothing PUD dispersion had a solids content of 50-55 percent by weight with ammonium stearate (STANFAX 320, Para-chem), disodium octadecyl sulfosuccinimate (STANFAX 318, Para-chem), cocamidopropyl betaine (STANFAX 590, Para-chem) and acrylic acid copolymer thickener (ACUSOL 810A, Dow). The thickened PUD viscosity was controlled to 15000 cp to 28000 cp. The detailed formulation as follows:

To make synthetic leather having a poromeric layer, the fabric was attached to pin frame. The frothing PUD was frothed using a Model 2MT1A foam machine (E.T. OAKES Corp.) run at 1000 rpm. The wet froth density was about 0.50-0.85 g/cm³. The froth was applied to fixed fabric using a Labcoater type LTE-S (Werner Mathic AG). The doctor knife was positioned at 1.8-2.5 mm between the roller and knife (including resin and fabric).

The frothed dispersion was dispersed and the doctor bladed to foam a coating of frothed PUD on the fabric. The coated fabric was then placed in an oven at 100° C. for 6 min, which was then heated to 170° C. in 5 min to form the synthetic leather having a poromeric layer.

### Inventive Example 2: Synthetic Leather Example 2

Prepolymer: PU prepolymer is prepared by charging 180 g Isonate 125 M into a three-neck flask, which was heated at 45 C for melt solid MDI to liquid. 324 g Voranal 9287A, 72 g PPG 425, 12 g DEG and 12 g MPEG 1000 are premixed and warmed at 55° C. for 1 h before added to flask. Increase the temperature to 80° C., keep 80° C. for 4-5 h to reach the target NCO % of 3.8% (NCO:OH=1.60).

PU dispersion: 524.2 g prepolymer was placed in a plastic jar. The jar was clamped and a Cowles blade was inserted into prepolymer such that the blade is just covered by prepolymer. 71.74 g DS-4 mixture was charged into prepolymer, following this procedure, the mixture was stirred with Cowles blade at 3000 rpm, and cold DI water (5° C.) is added into the mixture slowly as the water-in-oil was converted into an oil-in-water dispersion. A solution of 49.4 g chain extender (10% AEEA in water) is slowly fed into the dispersion with random stirring. The solid content of final dispersion PUD 2 is 55%.

Synthetic Leather

A poromeric layer of the synthetic leather was made using frothing PUD. The frothing PUD dispersion had a solids content of 50-55 percent by weight with ammonium stearate (STANFAX 320, Para-chem), disodium octadecyl sulfosuccinimate (STANFAX 318, Para-chem), cocamidopropyl betaine (STANFAX 590, Para-chem) and acrylic acid copolymer thickener (ACUSOL 810A, Dow). The thickened PUD viscosity was controlled to 15000 cp to 28000 cp. The detailed formulation as follows:

To make synthetic leather having a poromeric layer, the fabric was attached to pin frame. The frothing PUD was frothed using a Model 2MT1A foam machine (E.T. OAKES Corp.) run at 1000 rpm. The wet froth density was about 0.50-0.85 g/cm3. The froth was applied to fixed fabric using a Labcoater type LTE-S (Werner Mathic AG). The doctor knife was positioned at 1.8-2.5 mm between the roller and knife (including resin and fabric). The frothed dispersion was dispersed and the doctor bladed to foam a coating of frothed PUD on the fabric. The coated fabric was then placed in an oven at 100° C. for 6 min, which was then heated to 170° C. in 5 min to form the synthetic leather having a poromeric layer.

### Inventive Example 3: Synthetic Leather Example 3

Prepolymer: PU prepolymer is prepared by charging 180 g Isonate 125 M into a three-neck flask, which was heated at 45° C. for melt solid MDI to liquid. 150 g Voranal 9287A, 12 g DEG, 246 g Rester 48 and 12 g MPEG 1000 are premixed and warmed at 55° C. for 1 h before added to flask. Increase the temperature to 80° C., keep 80° C. for 4-5 h to reach the target NCO % of 3.9% (NCO:OH=1.63).

PU dispersion: 524.2 g prepolymer was placed in a plastic jar. The jar was clamped and a Cowles blade was inserted into prepolymer such that the blade is just covered by prepolymer. 71.74 g DS-4 mixture was charged into prepolymer, following this procedure, the mixture was stirred with Cowles blade at 3000 rpm, and cold DI water (5° C.) is added into the mixture slowly as the water-in-oil was converted into an oil-in-water dispersion. A solution of 48.36 g chain extender (10% AEEA in water) is slowly fed into the dispersion with random stirring. The solid content of final dispersion PUD 3 is 55%.

Synthetic Leather

A poromeric layer of the synthetic leather was made using frothing PUD. The frothing PUD dispersion had a solids content of 50-55 percent by weight with ammonium stearate (STANFAX 320, Para-chem), disodium octadecyl sulfosuccinimate (STANFAX 318, Para-chem), cocamidopropyl betaine (STANFAX 590, Para-chem) and acrylic acid copolymer thickener (ACUSOL 810A, Dow). The thickened PUD viscosity was controlled to 15000 cp to 28000 cp. The detailed formulation as follows:

To make synthetic leather having a poromeric layer, the fabric was attached to pin frame. The frothing PUD was frothed using a Model 2MT1A foam machine (E.T. OAKES Corp.) run at 1000 rpm. The wet froth density was about 0.50-0.85 g/cm³. The froth was applied to fixed fabric using a Labcoater type LTE-S (Werner Mathic AG). The doctor knife was positioned at 1.8-2.5 mm between the roller and knife (including resin and fabric). The frothed dispersion was dispersed and the doctor bladed to foam a coating of frothed PUD on the fabric. The coated fabric was then placed in an oven at 100° C. for 6 min, which was then heated to 170° C. in 5 min to form the synthetic leather having a poromeric layer.

### Procedure of Poromeric Layer Embossing

The poromeric synthetic leather was placed in a 190° C. oven and heated for 10 minutes. Then it was pressed (1-10 MPa) for 3 seconds in a cool press machine.

Results of Foam Layer Embossing

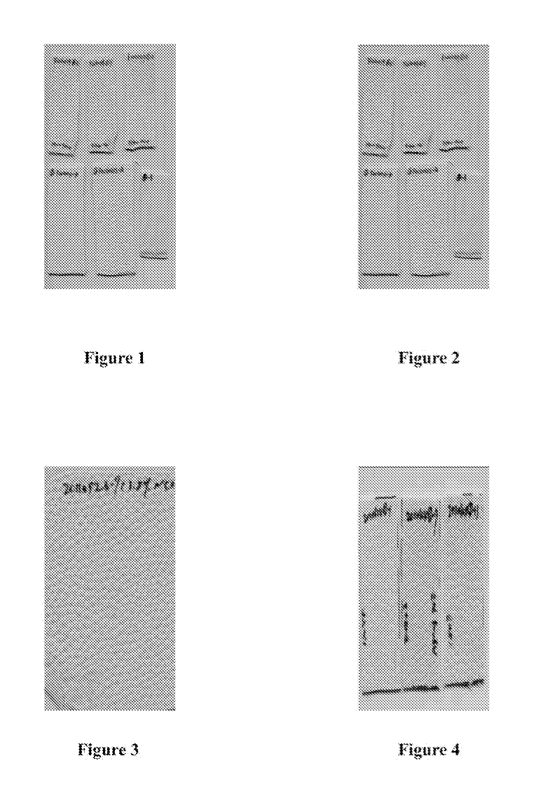

FIGS. 1-4 show the results of synthetic leathers that were embossed as described above. After embossing, the samples were first allowed to sit at room temperature and then heated to 90° C. in an oven for 5 hours, in order to simulate the effects of aging. The pictures below are of the samples after the 5 hour, 90° C. treatment, except for the picture of the control sample, which lost its embossing while sitting at room temperature. Thus, the control sample was not subjected to simulated aging conditions.

The control sample (FIG. 1) is based on Syntegra 3000, which is a PUD product for synthetic leather developed by Dow. It is based on a urea/urethane dispersion, where the ratio of urea to urethane is 1.458:1. As can be seen, the pattern embossed in the control sample (FIG. 1) has “relaxed,” i.e., is difficult to discern and is not acceptable. Again, this relaxation of the embossing pattern occurred at room temperature.

In contrast, the synthetic leathers made from a combination of at least two polyols and having a lowered NCO ratio have maintained the embossed pattern, and are acceptable. For example, PUD 1 (FIG. 2) has a urea/urethane dispersion with the urea/urethane ratio of 0.66:1. The pattern embossed onto it looks better than that of the control sample.

When the urea/urethane ratio drops to 0.36:1, the pattern is plump did not recover at 90° C. aging (FIG. 3, sample 2). Thus, it has acceptable embossing characteristics.

Sample 3 (FIG. 4) made from a PUD (urea/urethane ratio is 0.378:1) that contains polyester polyol, also passed the embossing test.

In summary, all experimental samples maintained the embossed pattern after sitting at room temperature, while the control sample did not. And FIGS. 1-4 clearly show that the claimed synthetic leathers maintained their embossing pattern, even after being artificially aged. Thus, the samples demonstrate that lower urea/urethane ratios lead to improved embossing characteristics.

What is claimed is:

1. Methods of preparing poromeric synthetic leathers having improved embossing characteristics, the methods comprising:
preparing a polyurethane prepolymer by reacting a mixture comprising, at least one isocyanate resin, and at least two polyols;
mixing said polyurethane prepolymer, with water, at least one surfactant and other optional additives to form a first mixture;
adding at least one chain extender to the first mixture to form a polyurethane/urea dispersion (PUD) having urea to urethane ratio of 0.9 to 0.06;
preparing a second mixture comprising the PUD, at least one thickening agent, and at least one surfactant;
frothing the second mixture and thereby forming a frothed second mixture;
applying the frothed second mixture to a fabric and thereby forming a coated fabric;
optionally adjusting the thickness of the frothed second mixture on the fabric; and
drying the coated fabric.

2. (canceled)

3. Methods according to claim 1, wherein at least one of the two polyols is a polyether polyol having an averang molecular weight of 400 to 1500 g/mol.

4. (canceled)

5. Methods according to claim 1, wherein at least one of the two polyols is Methoxy Polyethylene Glycol (MPEG).

6. Methods according to claim 1, wherein the polyurethane prepolymer is made by combining a liquid isocyanate resin and at least two liquid polyols.

7. (canceled)

8. Methods according to claim 1, wherein preparing the polyurethane prepolymer comprises melting the isocyanate resin, heating the at least one polyol and then combining the melted isocyanate resin and the heated at least one polyol.

9. Methods according to claim 1, wherein the polyurethane prepolymer comprises at least three polyols.

10. (canceled)

11. Method according to claim 9, wherein one of the at least three polyols is polypropylene glycol.

12. Methods according to claim 1, wherein the isocyanate comprises diisocyanatodiphenylmethane (MDI).

13. Methods according to claim 1, wherein the solid content of the first mixture is 45-65%.

14. Methods according to claim 1. wherein the polyurethane prepolymer contains less than five polyols and the chain extender comprises at least two amine groups.

15. Methods according to claim 1, wherein at least one isocyanate resin is methylenediphenyl diisocyanate, and wherein the chain extender comprises water, aminoethylethanolamine, or combinations thereof.

16. Methods according to claim 1, wherein in the polyurethane prepolymer, the ratio of the polyols to the isocyanate is from 1:1 to 4:1.

17. Methods according to claim 1, wherein the ratio of the first surfactant to the polyurethane prepolymer is from 1:5 to 0.01:5.

18. Methods according to claim 1, wherein each polyol has an average molecular weight of less than 2000 g/mol.

19. Methods according to claim 1, comprising
melting 4,4′- methylenediphenyl diisocyanate;
preparing a polyol mixture comprising at least two polyols, wherein at least one polyol is a polyether polyol;
heating the mixture of at least two polyols to a temperature of at least 30° C. (preferably, 30-60° C.);
optionally adding a base scavenger to said polyol mixture;
preparing a polyurethane prepolymer by reacting a mixture comprising the melted diisocyanate, the heated polyol mixture and the optional base scavenger;
mixing said polyurethane prepolymer with water, at least one surfactant, and water, to form a first mixture;
adding at least one chain extender to the first mixture to form a polyurethane dispersion (PUD) having urea to urethane ratio of 0.9 to 0.06;
mixing the PUD;
preparing a second mixture comprising the PUD, at least two surfactants, and a thickener;
frothing the second mixture and thereby forming a frothed second mixture;
applying the frothed second mixture to a fabric and thereby forming a coated fabric;
optionally adjusting the thickness of the frothed second mixture on the fabric; and
drying the coated fabric.

20. (canceled)

21. Poromeric, synthetic leathers having improved embossing characteristics made according to claim 1.
